(19) United States
(12) Patent Application Publication
(10) Pub. No.: US 2010/0082712 A1
(43) Pub. Date: Apr. 1, 2010

(54) Location and Time Based Media Retrieval

(76) Inventors: James Pratt, Round Rock, TX (US); Marc Sullivan, Austin, TX (US); Miles Pierce, Austin, TX (US)

Correspondence Address: AT&T Legal Department - HBH;Attn: Patent Docketing, One AT&T Way, Room 2A-207, Bedminster, NJ, 07921, US

(21) Appl. No.: 12/234,909

(22) Filed: Sep. 22, 2008

(51) Int. Cl. G06F 17/30; G01C 21/00

(52) U.S. Cl. 707/821; 701/213; 707/E17.02; 707/E17.143

(57) ABSTRACT

Methods, systems, and computer-readable media provide for location and time based media retrieval. A media file of an event recorded through a multimedia recording device is retrieved. The location of the multimedia recording device is determined. A temporal measurement associated with the event is also determined. The location and the temporal measurement are associated with the media file. The media file may be searchable via the location and the temporal measurement.

### BACKGROUND

Conventional search engine applications typically perform content-based searching of multimedia content, such as text, images, audio, video, and combinations thereof, stored on a database. For example, a user may retrieve a desired video clip from a collection of video clips by entering one or more relevant keywords into the search engine application. These keywords may include any relevant text associated with the video clip. For example, the keywords may include the subject matter or the file type of the desired video clip. Upon receiving the keywords, the search engine application may compare the keywords with an inverted index or other suitable data structure in order to retrieve the video clips associated with the keywords.

Content-based searching is generally limited to the information that can be associated with the content when the content is stored and to the interface provided by the search engine application presented to the user. For example, when a user uploads a video clip on YOUTUBE from GOOGLE, INC., the user may enter some limited information about the video clip, such as a title, a brief description, and various tags. This user-provided information is used by the search engine application to provide content-based searching. In some instances, the search engine application may also limit its interface to the information that the user was able to enter when the content was uploaded.

Conventional search engine applications typically do not provide functionality for searching and retrieving content based on specific times and/or locations associated with the content. For example, a user may have no way to search for a video clip of a specific occurrence within a larger event (e.g., a particular touchdown during a football game) based on the specific time and/or location of the occurrence or event. Further, any information regarding specific times and/or locations manually entered by the user into the database when uploading the content may be inconsistent and/or inaccurate. In addition, the devices used to generate the content may not provide functionality for recording the specific times and/or locations associated with the content.

### SUMMARY

Embodiments of the disclosure presented herein include methods, systems, and computer-readable media for location and time based media retrieval. According to one aspect, a method for generating a media file is provided. According to the method, a media file of an event recorded through a multimedia recording device is retrieved. The location of the multimedia recording device is determined. A temporal measurement associated with the event is also determined. The location and the temporal measurement are associated with the media file. The media file may be searchable via the location and the temporal measurement.

According to another aspect, a system for generating a media file is provided. The system includes a memory and a processor functionally coupled to the memory. The memory stores a program containing code for generating the media file. The processor is responsive to computer-executable instructions contained in the program and operative to receive a media file of an event recorded through a multimedia recording device, store the recorded event in the media file, determine a location of the multimedia recording device, determine a temporal measurement associated with the event, and associate the location and the temporal measurement with the media file. The media file may be searchable via the location and the temporal measurement.

According to yet another aspect, a computer-readable medium having instructions stored thereon for execution by a processor to perform a method for generating a media file is provided. According to the method, a media file of an event recorded through a multimedia recording device is retrieved. The location of the multimedia recording device is determined. A temporal measurement associated with the event is also determined. The location and the temporal measurement are associated with the media file. The media file may be searchable via the location and the temporal measurement.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 depicts a network architecture operative to enable location and time based media retrieval, in accordance with exemplary embodiments.

FIG. 2 is a diagram illustrating a portion of an embedded media file, in accordance with exemplary embodiments.

FIG. 3 is a flow diagram illustrating a method for generating a media file, in accordance with exemplary embodiments.

FIG. 4 is a computer architecture diagram showing aspects of an illustrative computer hardware architecture for a computing system capable of implementing aspects of the embodiments presented herein.

### DETAILED DESCRIPTION

The following detailed description is directed to providing time and location based media retrieval. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

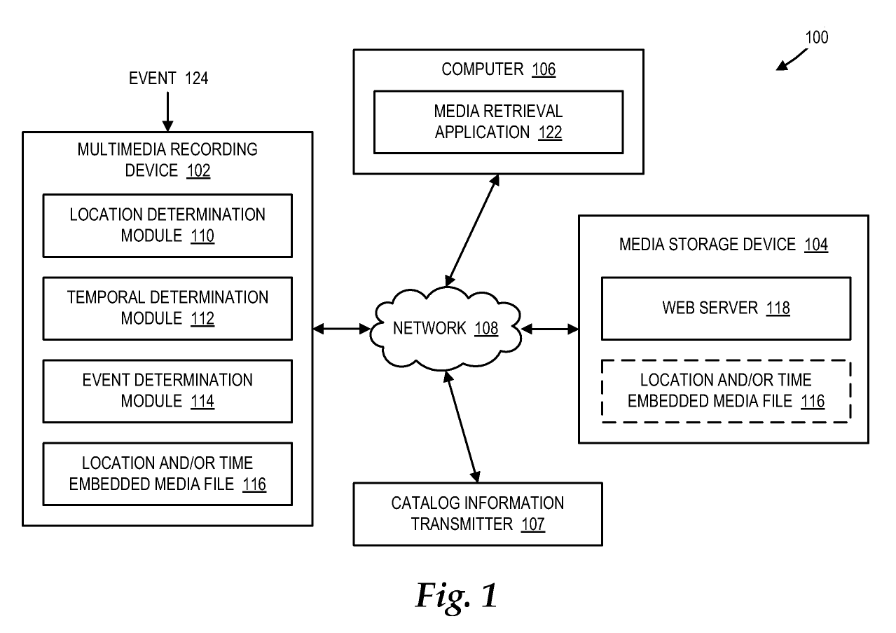

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for providing time and location based media retrieval will be described. FIG. 1 shows an illustrative network architecture 100 operative to enable time and location based media retrieval. In particular, the network architecture 100 includes a multimedia recording device 102, a media storage device 104, a computer 106, and a catalog information transmitter 107 operatively coupled via a network 108. According to exemplary embodiments, the multimedia recording device 102 includes a location determination module 110, a temporal determination module 112, an event determination module 114, and a location and/or time embedded media file (hereinafter referred to as an “embedded media file”) 116. The media storage device 104 includes a web server 118 and the embedded media file 116. The dotted line representation of the embedded media file 116 indicates that the embedded media file 116 may be stored on the media storage device 104 upon being uploaded from the multimedia recording device 102 or other suitable device via the network 108. The computer 106 includes a media retrieval application 122.

According to embodiments, the multimedia recording device 102 is operative to record an event 124 in any suitable digital media format. In particular, the multimedia recording device 102 may be any device capable of recording images, audio, video, or combinations thereof. Examples of the multimedia recording device 102 may include, but are not limited to, still cameras, voice recorders, and video cameras. As used herein, the term “event” refers to any subject capable of being recorded by the multimedia recording device 102.

As illustrated in the example of FIG. 1, the multimedia recording device 102 includes the location determination module 110. The location determination module 110 may be embodied as hardware, software, firmware, or combinations thereof and operative to determine the location (also referred to herein as location information) of the multimedia recording device 102. The location determination module 110 may utilize any suitable technology including, but not limited to, triangulation, trilateration, and multilateration. In one embodiment, the location determination module 110 is a global positioning system (“GPS”) receiver operative to determine the location of the multimedia recording device 102 based on GPS satellite signals. In a further embodiment, the location determination module 110 may include a user interface enabling a user to manually enter the location of the multimedia recording device 102.

As illustrated in the example of FIG. 1, the multimedia recording device 102 further includes the temporal determination module 112. The temporal determination module 112 may be embodied as hardware, software, firmware, or combinations thereof and operative to determine a time, date, or other suitable temporal measurement associated with the event 124 being recorded by the multimedia recording device 102. The time may include a specific time or a time frame. The time may be based on a suitable time standard (e.g., 5:00 pm Eastern Standard Time), such as the International Atomic Time (“TAI”), or may be relative to the event 124 (e.g., at the four minute mark of the third quarter of a football game). The date may be based on any suitable calendar system, such as the Gregorian calendar or the lunar calendar. In one embodiment, the temporal determination module 112 includes a user interface enabling a user to manually enter a temporal measurement associated with the event 124 being recorded by the multimedia recording device 102.

As illustrated in the example of FIG. 1, the multimedia recording device 102 further includes the event determination module 114. The event determination module 114 may be embodied as hardware, software, firmware, or combinations thereof and operative to determine event information, such as an event type, associated with the event 124. In one embodiment, the event determination module 114 utilizes suitable image processing and image understanding techniques as contemplated by those skilled in the art in order to determine the type of event being recorded by the multimedia recording device 102. For example, the event determination module 114 may analyze a video stream recorded by the multimedia recording device 102 to determine, among other things, that the video stream includes ten human participants running between two goals with a round, bouncing ball. In this illustrative example, the event determination module 114 may determine that the event 124 contained in the video stream is a basketball game. One example of the event determination module 114 is PHOTOSYNTH from MICROSOFT LIVE LABS and MICROSOFT CORPORATION. It should be appreciated that other techniques for detecting and determining events may be contemplated by those skilled in the art. In one embodiment, the event determination module 114 includes a user interface enabling a user to manually enter the event information associated with the event 124 recorded by the multimedia recording device 102.

Upon recording the event 124, the multimedia recording device 102 generates the embedded media file 116. The embedded media file 116 may be an image file, an audio file, a video file, or other suitable multimedia file. Examples of conventional image file formats include, but are not limited, Joint Photographic Experts Group (“JPEG”), Tagged Image File Format (“TIFF”), Portable Network Graphics (“PRG”), and Graphics Interchange Format (“GIF”). Examples of conventional audio file formats include, but are not limited to, Waveform (“WAV”), MPEG-1 Audio Layer 3 (“MP3”), Advanced Audio Coding (“AAC”), and Ogg. Examples of conventional video file formats include, but are not limited to, MPEG-4 and Audio Video Interleave (“AVI”).

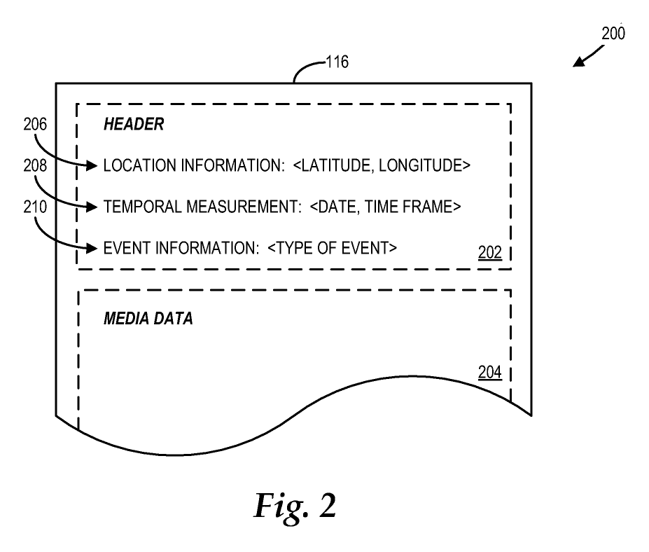

According to embodiments, the embedded media file 116 is embedded with location information from the location determination module 110, a temporal measurement from the temporal determination module 112, and/or event information from the event determination module 114. The location information, the temporal measurement, and the event information for a given event, such as the event 124, may be collectively referred to herein as catalog information. The catalog information may include any user-generated and system-generated information associated with the embedded media file 116. In one embodiment, the embedded media file 116 may include a dedicated portion, such as a header 202 illustrated in FIG. 2, that contains the catalog information. The header 202 is described in greater detail below with respect to FIG. 2. In another embodiment, the catalog information is not embedded in the embedded media file 116 but instead is stored in a separate file (not shown) attached to a conventional media file (also not shown).

Without standardization of the location information, the temporal measurement, and/or the event information, multiple multimedia recording devices recording the same event may embed different catalog information into the respective embedded media files. For example, the event information associated with a video recording of a basketball game between McNeil High School and Westwood High School may be embedded with “McNeil basketball game”, “McNeel basketball game”, “Westwood basketball game”, and “McNeil-Westwood game”. Inconsistencies (e.g., misspellings, mislabeling, etc.) in the catalog information may reduce the effectiveness of retrieval programs, such as the media retrieval application 122 described in greater detail below, to retrieve relevant media files based on the catalog information. In the above example, a search for “McNeil basketball” may not retrieve video files embedded with “McNeel basketball game”, “Westwood basketball game”, and even possibly “McNeil-Westwood game”.

In order to reduce the potential for inconsistent catalog information, the event determination module 114 includes a receiver capable of receiving the catalog information from the catalog information transmitter 107, according to one embodiment. For example, the catalog information transmitter 107 may transmit the catalog information to the location determination module 110, the temporal determination module 112, and/or the event determination module 114 via a broadcast (e.g., through a picocell), peer-to-peer (e.g., between cellular devices, such as cellular phones, smartphones, and personal digital assistants (“PDAs”)), or other suitable techniques. By transmitting the catalog information from a central source to multiple receivers, the catalog information can be standardized for multiple multimedia recording devices, such as the multimedia recording device 102, that are concurrently recording the event 124. That is, the catalog information transmitter 107 can ensure that multiple recordings of the same event information are embedded with the same catalog information, thereby increasing the effectiveness of retrieval applications, such as the media retrieval application 122.

As illustrated in the example of FIG. 1, the network architecture 100 further includes the media storage device 104 and the computer 106. The media storage device 104 is operative to store multimedia files, such as the embedded media file 116. In one embodiment, the media storage device 104 includes a web server, such as the web server 118, enabling communications with the multimedia recording device 102, the computer 106, and other suitable devices coupled to the network 108. In particular, the web server 118 may enable a user to upload, via the network 108, the embedded media file 116 from the multimedia recording device 102 or other suitable device. Upon receiving the embedded media file 116, the web server 118 may also enable the computer 106 to retrieve, via the network 108, the embedded media file 116 from the media storage device 104.

The computer 106 includes the media retrieval application 122 operative to provide a user interface enabling a user to retrieve the embedded media file 116 based on search criteria corresponding to at least a portion of the catalog information. In one embodiment, the media retrieval application 122 is a search engine application in which a user can enter the search criteria corresponding to the location information, the temporal measurement, and/or the event information. The media retrieval application 122 may query the media storage device 104 based on the search criteria, and the media storage device 104 may return relevant results corresponding to the search criteria.

In further embodiments, the media retrieval application 122 may include other suitable applications capable of utilizing one or more media files as retrieved based on the search criteria. For example, the media retrieval application 122 may be an application program that is operative to append multiple media files associated with the same event. If a user recording a video of the event 124 arrives five minutes late to the event 124, the embedded media file 116 will not include the first five minutes of the event 124. In this case, the user may utilize the media retrieval application 122 to retrieve media of the first five minutes of the event 124 and to append the media of the first five minutes of the event 124 to the embedded media file 116.

Referring now to FIG. 2, an illustrative example of a portion 200 of the embedded media file 116 is shown. The embedded media file 116 includes the header 202 and media data 204. The media data 204 includes machine-readable code representing the event 124 as recorded by the multimedia recording device 102. For example, the media data 204 may include similar data found in conventional multimedia file formats, such as the image file formats, the audio file formats, and the video file formats previously described. The media data 204 may be based on proprietary and/or open-source representations of the event 124 as recorded by the multimedia recording device 102.

As illustrated in the example of FIG. 2, the header 202 includes catalog information, such as location information 206, a temporal measurement 208, and event information 210. As previously described, the catalog information may include user-generated information and/or system-generated information. The location information 206 may be determined by the location determination module 110, and the temporal measurement 208 may be determined by the temporal determination module 112. The event information 210 may be determined by the event determination module 114. In one embodiment, the location information 206 includes GPS coordinates containing corresponding latitude and longitude coordinates associated with the multimedia recording device 102. In further embodiments, the location information 206 may include a street address, a point of interest (“POI”) name (e.g., McNeil High School, Lake Travis), or other suitable representation of a given location where the event 124 occurs.

The temporal measurement 208 includes any suitable temporal measurement, such as a time, a date, and/or a time frame, when the event 124 occurred. The time may include a specific time (e.g., a time when the event 124 began or finished) or a time frame (e.g., the time frame between when the event 124 began and finished). As previously described, the specific time and the time frame may be based on a suitable time standard, such as TAI, or may be relative to the event 124.

In one embodiment, the event information 210 includes an event type of the event 124. For example, if the event determination module 114 determines that the event 124 is a basketball game, the event information 210 may include the tag “basketball game”. In further embodiments, the event information 210 may include other suitable descriptors describing the event 124, such as the name of the event 124, the participants of the event 124, and/or the sponsor of the event 124.

In order to standardize the content of the catalog information, such as the location information 206, the temporal measurement 208, and the event information 210, the catalog information transmitter 107 as previously described may transmit the catalog information to multiple multimedia recording devices, such as the multimedia recording device 102. By originating the catalog information from a single source, in this case the catalog information transmitter 107, multiple multimedia recording devices recording the same event can embed into their respective media files the same catalog information. It should be appreciated that the catalog information may be generated and incorporated into the header 202 before, during, or after recording the event 124.

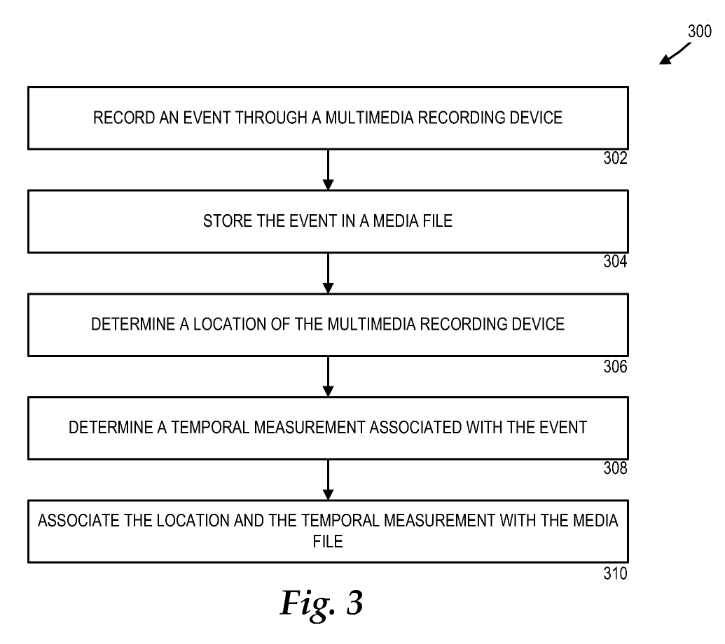

FIG. 3 is a flow diagram illustrating a method 300 for generating a media file, such as the embedded media file 116, in accordance with exemplary embodiments. By associating (e.g., embedding) catalog information, such as the location and the temporal measurement, with the media file, the media retrieval application 122 and other suitable application programs can efficiently retrieve and utilize the media file according to the catalog information. According to the method 300, the multimedia recording device 102 records (at 302) an event, such as the event 124. Upon recording the event 124, the multimedia recording device 102 stores (at 304) the event 124 in a media file, such as the embedded media file 116.

The location determination module 110 determines (at 306) a location of the multimedia recording device 102. For example, the location determination module 110 may determine GPS coordinates specifying the location of the multimedia recording device 102. Further, the temporal determination module 112 determines (at 308) a temporal measurement associated with the event 124. As previously described, the temporal measurement may be a specific time or a time frame based on a suitable time standard or relative to the event 124. Upon determining the location of the multimedia recording device 102 and the temporal measurement associated with the event 124, the multimedia recording device 102 associates (at 310) the location and the temporal measurement with the media file. For example, the multimedia recording device 102 may embed the location and the temporal measurement with the media file to form the embedded media file 116.

The embedded media file 116 may be uploaded to the media storage device 104 or other suitable storage device and accessed by the media retrieval application 122 via the network 108. In particular, the media retrieval application 122 may retrieve the embedded media file 116 based on the location, the temporal measurement, and/or other suitable catalog information that is embedded into the embedded media file 116.

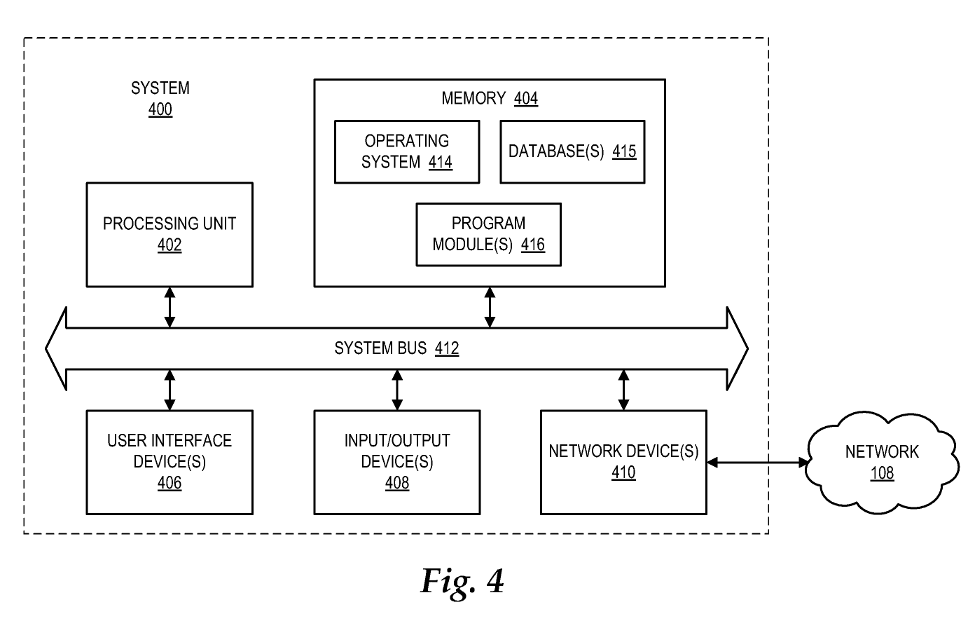

FIG. 4 and the following discussion are intended to provide a brief, general description of a suitable computing environment in which embodiments may be implemented. While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

FIG. 4 is a block diagram illustrating a system 400 operative to provide location and time based media retrieval, in accordance with exemplary embodiments. The system 400 includes a processing unit 402, a memory 404, one or more user interface devices 406, one or more input/output (“I/O”) devices 408, and one or more network devices 410, each of which is operatively connected to a system bus 412. The bus 412 enables bi-directional communication between the processing unit 402, the memory 404, the user interface devices 406, the I/O devices 408, and the network devices 410. Examples of the system 400 include, but are not limited to, computers, servers, personal digital assistants, cellular phones, or any suitable computing devices. Examples of computing devices may include the multimedia recording device 102, the media storage device 104, the computer 106, and the catalog information transmitter 107.

The processing unit 402 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 404 communicates with the processing unit 402 via the system bus 412. In one embodiment, the memory 404 is operatively connected to a memory controller (not shown) that enables communication with the processing unit 402 via the system bus 412. The memory 404 includes an operating system 414, one or more databases 415, and one or more program modules 416, according to exemplary embodiments. An example of the database 415 may be the media storage device 104. Examples of the program modules 416 may include the location determination module 110, the temporal determination module 112, the event determination module 114, the web server 118, and the media retrieval application 122. In one embodiment, the method 300 for generating a media file as described above with respect to FIG. 3 may be embodied as one of the program modules 416. Examples of operating systems, such as the operating system 414, include, but are not limited to, WINDOWS and WINDOWS MOBILE operating systems from MICROSOFT CORPORATION, MAC OS operating system from APPLE CORPORATION, LINUX operating system, SYMBIAN OS from SYMBIAN SOFTWARE LIMITED, BREW from QUALCOMM INCORPORATED, and FREEBSD operating system.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the system 400.

The user interface devices 406 may include one or more devices with which a user accesses the system 400. The user interface devices 406 may include, but are not limited to, computers, servers, personal digital assistants, cellular phones, or any suitable computing devices. The I/O devices 408 may enable a user to interface with the multimedia recording device 102 and the computer 106, for example. In one embodiment, the I/O devices 408 are operatively connected to an I/O controller (not shown) that enables communication with the processing unit 402 via the system bus 412. The I/O devices 408 may include one or more input devices, such as, but not limited to, a keyboard, a mouse, or an electronic stylus. Further, the I/O devices 408 may include one or more output devices, such as, but not limited to, a display screen or a printer.

The network devices 410 enable the system 400 to communicate with other networks or remote systems via a network, such as the network 108. Examples of network devices 410 may include, but are not limited to, a modem, a radio frequency (“RF”) or infrared (“IR”) transceiver, a telephonic interface, a bridge, a router, or a network card. The network 108 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 108 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A method for generating a media file, comprising:
receiving a media file of an event recorded through a multimedia recording device;
determining a location of the multimedia recording device;
determining a temporal measurement associated with the event; and
associating the location and the temporal measurement with the media file, the media file being searchable via the location and the temporal measurement.

2. The method of claim 1, wherein associating the location and the temporal measurement with the media file comprises embedding the location and the temporal measurement into a header within the media file.

3. The method of claim 1, further comprising:
determining event information associated with the event by performing image or video processing on the media file; and
associating the event information with the media file, the media file being further searchable via the event information.

4. The method of claim 1, further comprising receiving at least one of the location, the temporal measurement, and event information associated with the event from a transmitter.

5. The method of claim 1, wherein determining a location of the multimedia recording device comprises determining global positioning system (GPS) coordinates specifying the location of the multimedia recording device through a GPS receiver.

6. The method of claim 1, wherein the temporal measurement comprises a specific time or a time frame relative to the event.

7. The method of claim 1, further comprising searching for the media file responsive to user input specifying the location and the temporal measurement.

8. A system for generating a media file, comprising:
a memory for storing a program containing code for generating a media file;
a processor functionally coupled to the memory, the processor being responsive to computer-executable instructions contained in the program and operative to:
receive a media file of an event recorded through a multimedia recording device,
store the recorded event in the media file,
determine a location of the multimedia recording device,
determine a temporal measurement associated with the event, and
associate the location and the temporal measurement with the media file, the media file being searchable via the location and the temporal measurement.

9. The system of claim 8, wherein to associate the location and the temporal measurement with the media file, the processor is further operative to embed the location and the temporal measurement into a header within the media file.

10. The system of claim 8, the processor being responsive to further computer-executable instructions contained in the program and operative to:
determine event information associated with the event by performing image or video processing on the media file, and
associate the event information with the media file, the media file being further searchable via the event information.

11. The system of claim 8, the processor being responsive to further computer-executable instructions contained in the program and operative to receive at least one of the location, the temporal measurement, and event information associated with the event from a transmitter.

12. The system of claim 8, wherein to determine a location of the multimedia recording device, the processor is further operative to determine global positioning system (GPS) coordinates specifying the location of the multimedia recording device through a GPS receiver.

13. The system of claim 8, wherein the temporal measurement comprises a time or a time frame relative to the event.

14. A computer-readable medium having instructions stored thereon for execution by a processor to provide a method for generating a media file, the method comprising:
receiving a media file of an event recorded through a multimedia recording device;
determining a location of the multimedia recording device;
determining a temporal measurement associated with the event; and
associating the location and the temporal measurement with the media file, the media file being searchable via the location and the temporal measurement.

15. The computer-readable medium of claim 14, wherein associating the location and the temporal measurement with the media file comprises embedding the location and the temporal measurement into a header within the media file.

16. The computer-readable medium of claim 14, the method further comprising:
determining event information associated with the event by performing image or video processing on the media file; and
associating the event information with the media file, the media file being further searchable via the event information.

17. The computer-readable medium of claim 14, the method further comprising receiving at least one of the location, the temporal measurement, and event information associated with the event from a transmitter.

18. The computer-readable medium of claim 14, wherein determining a location of the multimedia recording device comprises determining global positioning system (GPS) coordinates specifying the location of the multimedia recording device through a GPS receiver.

19. The computer-readable medium of claim 14, wherein the temporal measurement comprises a time or a time frame relative to the event.

20. The computer-readable medium of claim 14, the method further comprising searching for the media file responsive to user input specifying the location and the temporal measurement.
